(19) United States
(12) Patent Application Publication
(10) Pub. No.: US 2024/0385354 A1
(43) Pub. Date: Nov. 21, 2024

(54) BROAD WAVELENGTH LOW REFLECTIVITY LIGHT ABSORBER

(71) Applicant: XEROX CORPORATION, Norwalk, CT (US)

(72) Inventors: Christopher L. Chua, San Jose, CA (US); Qian Wang, Mountain View, CA (US); Yu Wang, Union City, CA (US); Yang Gao, San Jose, CA (US)

(21) Appl. No.: 18/197,278

(22) Filed: May 15, 2023

(51) Int. Cl. G02B 5/00

(52) U.S. Cl. CPC G02B 5/003

(57) ABSTRACT

A light absorbing clement includes a phase match composite layer comprising a composite dielectric film with constituents having differing refractive indices, a metal layer, and a light absorbing carbon layer disposed between the metal layer and the phase match composite layer.

### FIELD

The present disclosure relates generally to light absorbing elements and method of making the same and optical sensors including the light absorbing element.

### SUMMARY

The present disclosure relates generally to light absorbing elements and method of making the same. These light absorbing elements may be utilized in an optical sensor device. The light absorbing element may shield an optical sensor from stray light and reduce noise in the optical sensor. The light absorbing element may reflect less than 10% of light incident on the light absorbing element across the visible light spectrum.

A light absorbing element includes a phase match composite layer comprising a composite dielectric film with constituents having differing refractive indices, a metal layer, and a light absorbing carbon layer disposed between the metal layer and the phase match composite layer.

The present disclosure is directed to a light absorbing element including a phase match composite layer having a composite dielectric film with constituents having differing refractive indices. The phase match composite layer has a first surface and an opposing second surface separated by a thickness. The light absorbing element includes a metal layer and a light absorbing carbon layer disposed between the metal layer and the first surface of the phase match composite layer. The light absorbing carbon layer has a first surface and an opposing second surface separated by a thickness.

The present disclosure is also directed to an optical sensor article including a silicon substrate, a light sensor disposed in or on the silicon substrate, and the light absorbing element described herein disposed on the silicon substrate and adjacent to the light sensor.

The present disclosure is also directed to a method of forming a light absorbing element. The method includes depositing a metal layer, depositing a light absorbing carbon layer on the metal layer, depositing a layer of silicon nitride onto the carbon layer, depositing a gradient layer of silicon nitride and silicon oxide onto the layer of silicon nitride by reducing an amount of nitrogen and increasing an amount of oxygen during the depositing a gradient layer step, and depositing a layer of silicon oxide onto the gradient layer, forming a phase match composite layer.

The present disclosure is also directed to a method of forming a light absorbing element. The method includes depositing a metal layer, depositing a graded carbon layer by co-depositing metal and carbon and adjusting the relative deposition rates of the composite or depositing a light absorbing carbon layer on the metal layer, depositing a layer of silicon nitride onto the carbon layer, depositing a gradient layer of silicon nitride and silicon oxide onto the layer of silicon nitride by reducing an amount of nitrogen and increasing an amount of oxygen during the depositing a gradient layer step, and depositing a layer of silicon oxide onto the gradient layer, forming a phase match composite layer.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a schematic diagram of an illustrative light absorbing element;

FIG. 2 is a schematic diagram of an illustrative phase match layer;

FIG. 3 is a schematic diagram of an illustrative light absorbing carbon layer;

FIG. 4 is a schematic diagram of another illustrative light absorbing element;

FIG. 5 is a schematic diagram of another illustrative light absorbing element;

FIG. 6 is a schematic diagram of an illustrative optical sensor article;

FIG. 7 is flow diagram illustrating steps in forming an illustrative light absorbing element;

FIG. 8 is a graph of reflectance of incident light from 400 nanometers to 1200 nanometers for Example 1;

FIG. 9 is a graph of reflectance of incident light from 400 nanometers to 1200 nanometers for Example 2; and

FIG. 10 is a graph of reflectance of incident light from 400 nanometers to 1200 nanometers for Example 3.

The figures are not necessarily to scale and are presented for purposes of illustration and not limitation. The figures depict one or more aspects described in this disclosure. However, it will be understood that other aspects not depicted in the figures fall within the scope and spirit of this disclosure.

### DETAILED DESCRIPTION

The present disclosure relates generally to light absorbing elements and method of making the same. These light absorbing elements may be utilized in an optical sensor. The light absorbing element may shield the optical sensor from stray light and reduce noise in the optical sensor. The light absorbing element may reflect less than 10% of light incident on the light absorbing element across the visible light spectrum.

The light absorbing element absorbs incident light across the visible light spectrum. Visible light spectrum refers to light from the near ultraviolet (UV) wavelength (400 nanometers) to the near infrared (IR) wavelengths (1200 nanometers). The light absorbing element may reflect less than 8% of light incident on the light absorbing element across the visible light spectrum, across all wavelengths from 400 nanometers to 1200 nanometers.

The present disclosure provides a light absorbing element that strongly absorbs optical energy or light from the near UV to the near IR. In some embodiments, light reflectivity is kept below 10% or below 8% or below 5% or below 3%, across the entire wavelength spectrum from 400 to 1200 nanometers.

These light absorbing elements may have a thickness of less than 1 micrometer. These light absorbing elements may have a thickness of less than 0.5 micrometer. These light absorbing elements may have a thickness of less than 0.4 micrometer.

The present disclosure provides embodiments employing various adhesion layers that improve the overall mechanical robustness of the light absorbing element while maintaining extraordinary light absorption.

The present disclosure provides methods for forming a unique light absorbing element. These methods include deposition techniques that form a composite dielectric film where a gradient layer of silicon nitride and silicon oxide is deposited by reducing an amount of nitrogen and increasing an amount of oxygen during the depositing a gradient layer step.

The present disclosure provides methods for forming a unique light absorbing carbon layer. These method include deposition techniques that form a light absorbing carbon layer by depositing a gradient layer of metal and carbon onto a metal layer, by co-depositing metal and carbon and reducing the deposition rate of metal relative to that of carbon during the depositing a light absorbing carbon layer step.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Devices such as low-noise imaging sensors require optical absorber thin films to be formed at certain locations of the device structure to shield sensitive portions of the device from stray light. These optical absorbers or light absorbing elements may define an optical cavity where light or imaging sensors reside. The optical absorber or light absorbing element strongly absorbs incident light across a broad band of wavelengths from the near UV to the near IR. The film reflectivity preferably is kept below 10% because reflections produce stray light that contribute to sensor noise. Despite their importance, simple and low-cost thin film absorbers or light absorbing elements are not readily available. Pure black carbon is an obvious candidate. However, such films, although capable of blocking light transmission at thin film thicknesses, still reflect over about 20% of incident light across the entire visible spectrum and as much as 30% in the near IR and suffer from poor adhesion to other typical light sensor materials.

The present disclosure relates generally to light absorbing elements and method of making the same. These light absorbing elements may be utilized in an optical sensor device. The light absorbing element may shield an optical sensor from stray light and reduce noise in the optical sensor. The light absorbing element may reflect less than 10%, or less than 8%, or less than 5%, or less than 3%, of light incident on the light absorbing element across the visible light spectrum.

A light absorbing element includes a phase match composite layer comprising a composite dielectric film with constituents having differing refractive indices, a metal layer, and a light absorbing carbon layer disposed between the metal layer and the phase match composite layer. The phase match composite layer bridges the difference in refractive index between air and carbon. It enables efficient transfer of electromagnetic waves or light that is incident on a surface of the phase match composite layer to the underlying carbon layer.

The present disclosure is directed to a light absorbing element including a phase match composite layer having a composite dielectric film with constituents having differing refractive indices. The phase match composite layer has a first surface and an opposing second surface separated by a thickness. The light absorbing element includes a metal layer and a light absorbing carbon layer disposed between the metal layer and the first surface of the phase match composite layer. The light absorbing carbon layer has a first surface and an opposing second surface separated by a thickness.

FIG. 1 is a schematic diagram of an illustrative light absorbing element 100. The light absorbing element 100 includes a phase match composite layer 110 including a composite dielectric film with constituents having differing refractive indices. The phase match composite layer 110 has a first surface 112 and an opposing second surface 114 separated by a thickness. A light absorbing carbon layer 130 is disposed between a metal layer 120 and the first surface 112 of the phase match composite layer 110. The light absorbing carbon layer 130 has a first surface 132 and an opposing second surface 134 separated by a thickness.

The light absorbing element 100 may reflect less than 10% of light incident on the light absorbing element across all wavelengths of the visible light spectrum from 400 nanometers to 1200 nanometers. The light absorbing element 100 may reflect less than less than 8% of light incident on the light absorbing element across all wavelengths of the visible light spectrum from 400 nanometers to 1200 nanometers. The light absorbing element 100 may reflect less than less than 5% of light incident on the light absorbing element across all wavelengths of the visible light spectrum from 400 nanometers to 1200 nanometers. The light absorbing element 100 may reflect less than less than 3% of light incident on the light absorbing element across all wavelengths of the visible light spectrum from 400 nanometers to 1200 nanometers.

The metal layer 120 may have a thickness T in a range from 50 to 200 nanometers. The metal layer 120 may have a thickness T in a range from 50 to 150 nanometers. The metal layer 120 may have a thickness T in a range from 50 to 100 nanometers. The metal layer 120 may be formed of a light reflecting metal. Exemplary metals includes aluminum, titanium, chromium, manganese, iron, cobalt nickel, copper, zinc, silver, gold, tin, platinum, lead, and tungsten. Exemplary metals include titanium, tungsten, silver, gold, and platinum. In some embodiments the metal is an alloy of titanium and tungsten.

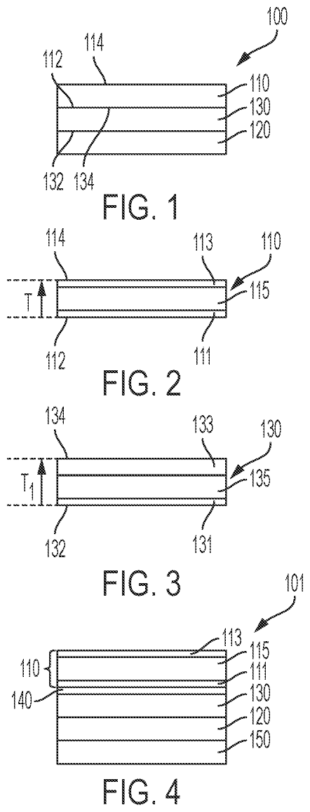

FIG. 2 is a schematic diagram of an illustrative phase match layer 110. The phase match composite layer 110 may include a layer of silicon oxynitride of a first composition 111 adjacent to the first surface 112. A layer of silicon oxynitride of a second composition 113 may be adjacent to the second surface 114. The second composition has more oxygen than the first composition.

The phase match composite layer 110 may include a graded composition defining the thickness T of the phase match composite layer 110. The graded composition increasing in an amount of oxygen along a thickness T direction from the first surface 112 to the opposing second surface 114.

The phase match composite layer 110 may include a graded composition defining the thickness T of the phase match composite layer 110. The graded composition decreasing in an amount of nitrogen along a thickness T direction from the first surface 112 to the opposing second surface 114.

The phase match composite layer 110 may include a gradient region 115 disposed between the first surface 112 and the second surface 114. The gradient region 115 may be formed by depositing silicon in a mix ambient comprising oxygen and nitrogen gas and adjusting the ratio of oxygen and nitrogen gas in the ambient to form silicon oxynitride with an oxygen to nitrogen stoichiometry that varies along the thickness of the gradient region 115. The gradient region 115 may include silicon oxynitride where the ratio of oxygen to nitrogen increases through the gradient region 115 from the first surface 112 to the second surface 114. The gradient region 115 may include silicon oxynitride where the ratio of nitrogen to oxygen stoichiometry decreases through the gradient region 115 from the first surface 112 to the second surface 114.

The phase match composite layer 110 may include a graded composition defining the thickness T of the phase match composite layer 110. The first surface 112 consists essentially of silicon nitride and the second surface 114 consists essentially of silicon oxide.

In some embodiments the first surface 112 is formed entirely of silicon nitride and the second surface 114 is formed entirely of silicon oxide. The first surface 112 formed entirely of silicon nitride may have a thickness of at least 10 nanometers thick, or at least 20 nanometers thick. The second surface 114 formed entirely of silicon oxide may have a thickness of at least 10 nanometers thick, or at least 20 nanometers thick.

The phase match composite layer 110 may have a thickness T in a range from 50 to 250 nanometers. The phase match composite layer 110 may have a thickness T in a range from 50 to 200 nanometers. The phase match composite layer 110 may have a thickness T in a range from 50 to 150 nanometers, or from 50 to 100 nanometers.

FIG. 3 is a schematic diagram of an illustrative light absorbing carbon layer 130. The light absorbing carbon layer 130 may include a layer of metal and carbon of a first composition 131 adjacent to the first surface 132. A layer of metal and carbon of a second composition 133 adjacent to the second surface 134 has more carbon than the first composition 131.

The light absorbing carbon layer 130 may include a graded composition defining the thickness T of the light absorbing carbon layer 130. The graded composition increasing in an amount of carbon along a thickness T₁ direction from the first surface 132 to the opposing second surface 134.

The light absorbing carbon layer 130 may include a graded composition defining the thickness T₁ of the light absorbing carbon layer 130. The graded composition decreasing in an amount of metal along a thickness T₁ direction from the first surface 132 to the opposing second surface 134.

The light absorbing carbon layer 130 may include a gradient region 135 disposed between the first surface 132 and the second surface 134. The gradient region 135 may be formed by co-depositing metal and carbon. The gradient region 135 may include metal and carbon where the ratio of carbon to metal increases through the gradient region 135 from the first surface 132 to the second surface 134. The gradient region 135 may include metal and carbon where the ratio of metal to carbon decreases through the gradient region 135 from the first surface 132 to the second surface 134.

The light absorbing carbon layer 130 may include a graded composition defining the thickness T₁ of the light absorbing carbon layer 130. The first surface 132 consists essentially of metal, and the second surface 134 consists essentially of carbon.

In some embodiments the first surface 132 is formed entirely of metal and the second surface 134 is formed entirely of carbon. The first surface 132 formed entirely of metal may have a thickness of at least 10 nanometers thick, or at least 20 nanometers thick. The second surface 134 formed entirely of carbon may have a thickness of at least 40 nanometers thick, or at least 60 nanometers thick.

The light absorbing carbon layer 130 may be formed of only carbon from the first surface 132 to the second surface 134. In these embodiments, metal is not co-deposited with carbon when forming the light absorbing carbon layer 130.

The light absorbing carbon layer 130 may have a thickness T in a range from 50 to 300 nanometers. The light absorbing carbon layer 130 may have a thickness T in a range from 50 to 250 nanometers. The light absorbing carbon layer 130 may have a thickness T in a range from 50 to 200 nanometers, or from 50 to 150 nanometers.

FIG. 4 is a schematic diagram of another illustrative light absorbing element 101. The light absorbing element 101 includes a phase match composite layer 110 including a composite dielectric film with constituents having differing refractive indices. The phase match composite layer 110 has a first surface and an opposing second surface separated by a thickness. A light absorbing carbon layer 130 is disposed between a metal layer 120 and the first surface of the phase match composite layer 110. The light absorbing carbon layer 130 has a first surface and an opposing second surface separated by a thickness. The phase match composite layer 110 may further include a further layer 140 forming the first surface 112 of the phase match composite layer 110.

The phase match composite layer 110 may include a layer of silicon oxynitride of a first composition 111 adjacent to the first surface. A layer of silicon oxynitride of a second composition 113 may be adjacent to the second surface. The second composition has more oxygen than the first composition. The further layer 140 may be formed of niobium pentoxide. The niobium pentoxide layer 140 may have a thickness in a range from 5 to 20 nanometers, or from 5 to 15 nanometers. The niobium pentoxide layer may improve light adsorption and further reduce light reflection across the visible light spectrum.

The light absorbing element 101 may reflect less than 10% of light incident on the light absorbing element across all wavelengths of the visible light spectrum from 400 nanometers to 1200 nanometers. The light absorbing element 101 may reflect less than less than 8% of light incident on the light absorbing element across all wavelengths of the visible light spectrum from 400 nanometers to 1200 nanometers. The light absorbing element 101 may reflect less than less than 5% of light incident on the light absorbing element across all wavelengths of the visible light spectrum from 400 nanometers to 1200 nanometers. The light absorbing element 101 may reflect less than less than 3% of light incident on the light absorbing element across all wavelengths of the visible light spectrum from 400 nanometers to 1200 nanometers.

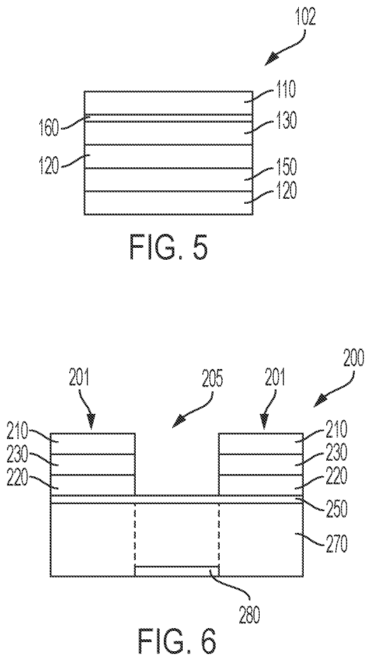

FIG. 5 is a schematic diagram of another illustrative light absorbing element 102. The light absorbing element 102 includes a phase match composite layer 110 including a composite dielectric film with constituents having differing refractive indices. The phase match composite layer 110 has a first surface and an opposing second surface separated by a thickness. A light absorbing carbon layer 130 is disposed between a metal layer 120 and the first surface of the phase match composite layer 110. The light absorbing carbon layer 130 has a first surface and an opposing second surface separated by a thickness. The phase match composite layer 110 may further include an adhesion layer 160 fixing the phase match composite layer 110 to the light absorbing carbon layer 130.

The phase match composite layer 110 may include a layer of silicon oxynitride of a first composition adjacent to the first surface 112. A layer of silicon oxynitride of a second composition may be adjacent to the second surface 114. The second composition has more oxygen than the first composition. The adhesion layer 160 may be formed of silicon carbide. The silicon carbide layer 160 may have a thickness in a range from 5 to 30 nanometers, or from 5 to 25 nanometers, or from 10 to 20 nanometers. The silicon carbide layer may improve adhesion of the phase match composite layer 110 to the light absorbing carbon layer 130 without increasing light reflection across the visible light spectrum.

The light absorbing element 102 may reflect less than 10% of light incident on the light absorbing element across all wavelengths of the visible light spectrum from 400 nanometers to 1200 nanometers. The light absorbing element 102 may reflect less than less than 8% of light incident on the light absorbing element across all wavelengths of the visible light spectrum from 400 nanometers to 1200 nanometers. The light absorbing element 102 may reflect less than less than 5% of light incident on the light absorbing element across all wavelengths of the visible light spectrum from 400 nanometers to 1200 nanometers. The light absorbing element 102 may reflect less than less than 3% of light incident on the light absorbing element across all wavelengths of the visible light spectrum from 400 nanometers to 1200 nanometers.

FIG. 6 is a schematic diagram of an illustrative optical sensor article 200. The optical sensor article 200 includes a silicon substrate 270, a light sensor 280 disposed within or on the silicon substrate 270, and a light absorbing element 201, described above, disposed in the silicon substrate 270 and adjacent to the light sensor 280.

The light absorbing element 201 includes a phase match composite layer 210 including a composite dielectric film with constituents having differing refractive indices. The phase match composite layer 210 has a first surface and an opposing second surface separated by a thickness.

A light absorbing carbon layer 130 is disposed between a metal layer 120 and the first surface of the phase match composite layer 110. The light absorbing carbon layer 130 has a first surface and an opposing second surface separated by a thickness.

An anti-reflective layer 250 may separate the metal layer 220 from the silicon substrate 270. The anti-reflective layer 250 may include a layer of silicon oxide disposed on a layer of silicon nitride. The anti-reflective layer 250 may extend along the surface of the silicon substrate 270 and overlay the light sensor 280. The anti-reflective layer 250 may extend along the surface of the silicon substrate 270 and define a bottom surface of a lateral optical cavity 205 at least partially defined by the light absorbing element 201.

The anti-reflective layer 250 may have a thickness in a range from 25 to 150 nanometers, or from 50 to 100 nanometers, or from 50 to 80 nanometers. The anti-reflective layer 250 layer of silicon oxide may have a thickness in a range from 20 to 75 nanometers, or from 25 to 60 nanometers. The anti-reflective layer 250 layer of silicon nitride may have a thickness in a range from 20 to 75 nanometers, or from 25 to 60 nanometers.

The light absorbing element 201 defines at least a portion of an optical cavity 205. The light sensor 280 disposed in the optical cavity 205. The light absorbing element 201 may define the an optical cavity 205.

The phase match composite layer 210 may further include an adhesion layer fixing the phase match composite layer 210 to the light absorbing carbon layer 230. The phase match composite layer 210 may include a layer of silicon oxynitride of a first composition adjacent to the first surface. A layer of silicon oxynitride of a second composition may be adjacent to the second surface. The second composition has more oxygen than the first composition. An adhesion layer may be formed of silicon carbide. The silicon carbide layer may have a thickness in a range from 5 to 30 nanometers, or from 5 to 25 nanometers, or from 10 to 20 nanometers. The silicon carbide layer has been shown to improve adhesion of the phase match composite layer 210 to the light absorbing carbon layer 230 without increasing light reflection across the visible light spectrum.

The light absorbing carbon layer 230 may include a layer of metal and carbon of a first composition adjacent to the first surface. A layer of metal and carbon of a second composition adjacent to the second surface has more carbon than the first composition. The light absorbing carbon layer 230 may include a gradient region disposed between the first surface and the second surface. The gradient region may include metal and carbon where the ratio of carbon to metal increases through the gradient region from the first surface to the second surface. The gradient region may include metal and carbon where the ratio of metal to carbon decreases through the gradient region from the first surface to the second surface.

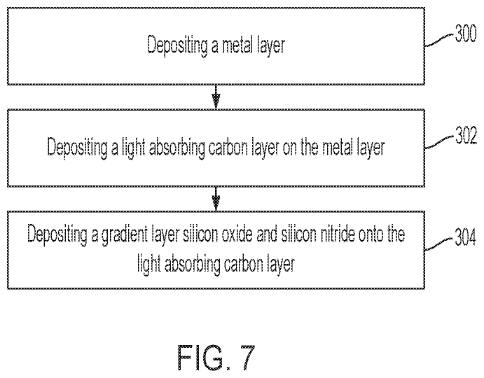

FIG. 7 is flow diagram illustrating steps in forming an illustrative light absorbing element. The method includes depositing a metal layer (300), depositing a light absorbing carbon layer on the metal layer (302), and depositing a gradient layer of silicon nitride and silicon oxide onto the light absorbing carbon layer (304).

The method of forming an illustrative light absorbing element may include, depositing a metal layer, depositing a light absorbing carbon layer on the metal layer, depositing a layer of silicon nitride onto the carbon layer, depositing a gradient layer of silicon nitride and silicon oxide onto the layer of silicon nitride by reducing an amount of nitrogen and increasing an amount of oxygen during the depositing a gradient layer step, and depositing a layer of silicon oxide onto the gradient layer, forming a phase match composite layer.

The method of forming an illustrative light absorbing element may further include depositing a silicon carbide layer onto the light absorbing carbon layer and then depositing a layer of silicon nitride onto the silicon carbide layer.

The phase match composite layer may have a thickness in a range from 50 to 200 nanometers, the light absorbing carbon layer has a thickness in a range from 50 to 250 nanometers, and the metal layer has a thickness in a range from 50 to 150 nanometers.

The depositing a gradient layer step may include depositing a gradient layer of silicon oxinitride onto the layer of silicon nitride, by depositing silicon in a mix of oxygen and nitrogen gas and changing the ratio of oxygen gas to nitrogen gas from a low oxygen to nitrogen ratio to a high oxygen to nitrogen ratio during the depositing a gradient layer step.

The depositing a gradient layer step may include depositing a light absorbing carbon layer step including depositing a gradient layer of metal and carbon onto the metal layer, by co-depositing metal and carbon simultaneously and changing relative deposition rates of the metal and carbon from a low carbon to metal rate ratio to a high carbon to metal rate ratio during the depositing a light absorbing carbon layer step.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

### EXAMPLES

Example 1—An illustrative light absorbing element includes an antireflection layer deposited on a silicon substrate. The antireflection layer includes a layer of silicon nitride (40 nm thick) and a layer of silicon oxide (35 nm thick). A metal layer formed of a titanium tungsten alloy (100 nm thick) is deposited on the antireflection layer. A light absorbing carbon layer (187 nm thick) is deposited on the metal layer. A phase match composite layer (150 nm thick) is deposited on the light absorbing carbon layer. The phase match composite layer has a first surface (contacting the light absorbing carbon layer) is formed of only silicon nitride and the opposing second surface is formed of only silicon oxide. Silicon is deposited in a mix of oxygen and nitrogen ambient between the first and second surfaces to form a silicon oxynitride with a graded oxygen to nitrogen stoichiometry along the thickness direction from the first to the second surfaces.

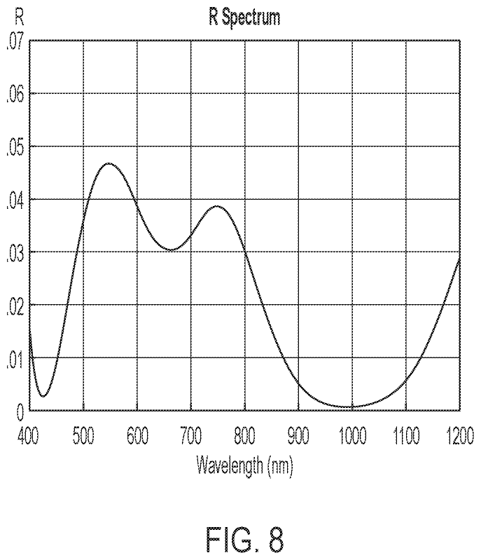

FIG. 8 is a graph of reflectance of incident light from 400 nanometers to 1200 nanometers. The y-axis is reflectance from 0 to 7%. This reflectance spectrum illustrates a maximum reflectance of less than 5% (0.05) which occurs at about 550 nanometers.

Example 2—Another illustrative light absorbing element includes an antireflection layer deposited on a silicon substrate. The antireflection layer includes a layer of silicon nitride (40 nm thick) and a layer of silicon oxide (35 nm thick). A metal layer formed of a titanium tungsten alloy (100 nm thick) is deposited on the antireflection layer. A light absorbing carbon layer (187 nm thick) is deposited on the metal layer. A phase match composite layer (150 nm thick) is deposited on the light absorbing carbon layer. The phase match composite layer has a first surface (contacting the light absorbing carbon layer) is formed of only silicon nitride and the opposing second surface is formed of only silicon oxide. Silicon is deposited in a mix oxygen and nitrogen ambient between the first and second surfaces to form silicon oxinitride with a graded oxygen to nitrogen stoichiometry along the thickness direction from the first to the second surfaces. A niobium pentoxide layer (12 nm thick) separates the first surface from the light absorbing carbon layer.

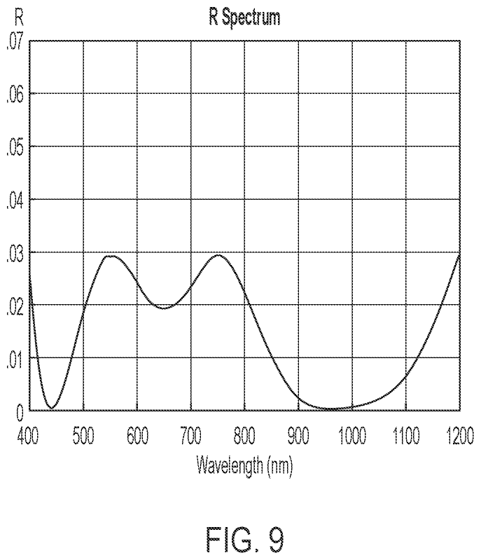

FIG. 9 is a graph of reflectance of incident light from 400 nanometers to 1200 nanometers. The y-axis is reflectance from 0 to 7%. This reflectance spectrum illustrates a maximum reflectance of less than 3% (0.03) which occurs at about 550, 750 and 1200 nanometers.

Example 3—Another illustrative light absorbing element includes an antireflection layer deposited on a silicon substrate. The antireflection layer includes a layer of silicon nitride (40 nm thick) and a layer of silicon oxide (35 nm thick). A metal layer formed of a titanium tungsten alloy (100 nm thick) is deposited on the antireflection layer. A light absorbing carbon layer (187 nm thick) is deposited on the metal layer. A phase match composite layer (150 nm thick) is deposited on the light absorbing carbon layer. The phase match composite layer has a first surface (contacting the light absorbing carbon layer) is formed of only silicon nitride and the opposing second surface is formed of only silicon oxide. Silicon is deposited in a mix oxygen and nitrogen ambient between the first and second surfaces to form silicon oxinitride with a graded oxygen to nitrogen stoichiometry along the thickness direction from the first to the second surfaces. A silicon carbide layer (10 nm thick) fixes the first surface to the light absorbing carbon layer.

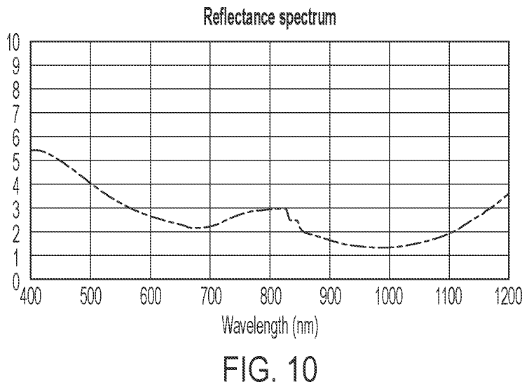

FIG. 10 is a graph of reflectance of incident light from 400 nanometers to 1200 nanometers. The y-axis is percent reflectance from 0 to 10%. This reflectance spectrum illustrates a maximum reflectance of less than 6% (0.06) which occurs at about 400 nanometers.

Example 4—Another illustrative light absorbing element includes an antireflection layer deposited on a silicon substrate. The antireflection layer includes a layer of silicon nitride (40 nm thick) and a layer of silicon oxide (35 nm thick). A metal layer formed of a titanium tungsten alloy (100 nm thick) is deposited on the antireflection layer. A light absorbing carbon layer (187 nm thick) is deposited on the metal layer. The light absorbing carbon layer has a portion of its thickness co-deposited with a titanium tungsten alloy. A phase match composite layer (150 nm thick) is deposited on the light absorbing carbon layer. The phase match composite layer has a first surface (contacting the light absorbing carbon layer) is formed of only silicon nitride and the opposing second surface is formed of only silicon oxide. Silicon is deposited in a mix oxygen and nitrogen ambient between the first and second surfaces to form silicon oxinitride with a graded oxygen to nitrogen stoichiometry along the thickness direction from the first to the second surfaces.

This light absorbing element is formed by RF and DC sputtering utilizing the following layer process parameters formed from bottom layer to top layer:

Antireflection layer - silicon target

| Layer | Gas (sccm) | Power (W) | Time (sec) | Thickness(nm) |
|---|---|---|---|---|
| SiN | Ar(25), N₂(10) 3.5 | 600 | 280 | 40 |
| | mtorr | | | |
| SiO₂ | O₂(40) 6 mtorr | 300 | 370 | 35 |

Metal-Carbon graded layer - TiW and Carbon targets

| Layer | Gas (sccm) | Power (W) | Time (sec) | Thickness(nm) |
|---|---|---|---|---|
| TiW/C1 | Ar(25) 6 mtorr | TiW(90)/C(100) | 90 | 100 nm |
| TiW/C2 | Ar(25) 6 mtorr | TiW(75)/C(200) | 90 | |
| TiW/C3 | Ar(25) 6 mtorr | TiW(60)/C(300) | 90 | |
| TiW/C4 | Ar(25) 6 mtorr | TiW(45)/C(400) | 90 | |
| TiW/C5 | Ar(25) 6 mtorr | TiW(30)/C(500) | 90 | |
| TiW/C6 | Ar(25) 6 mtorr | TiW(15)/C(600) | 90 | |
| Carbon | Ar(25) 6 mtorr | TiW(0)/C(650) | 600 | |

Phase match composite layer (gradient of layer) - Si target

| | | Power | Time | Thick- |
|---|---|---|---|---|
| Layer | Gas (sccm) | (W) | (sec) | ness(nm) |
| SiN | Ar(35), N₂(10), O₂(0) 3.5 mtorr | 600 | 170 | 85 nm |
| SiON1 | Ar(22), N₂(7.5), O₂(5) 3 mtorr | 600 | 40 | |
| SiON2 | Ar(15), N₂(5), O₂(10) 3 mtorr | 600 | 40 | |
| SiON3 | Ar(7), N₂(3), O₂(15) 3 mtorr | 600 | 40 | |
| SiO₂ | Ar(0), N₂(0), O₂(40) 3.5 mtorr | 600 | 115 | |

The oxygen was provided as 15% oxygen in argon gas.

1. A light absorbing element, comprising;
a phase match composite layer comprising a composite dielectric film with constituents having differing refractive indices, the phase match composite layer having a first surface and an opposing second surface separated by a thickness;
a metal layer; and
a light absorbing carbon layer disposed between the metal layer and the first surface of the phase match composite layer, the light absorbing carbon layer having a first surface and an opposing second surface separated by a thickness.

2. The light absorbing element according to claim 1, wherein the phase match composite layer comprises a layer of silicon oxynitride of a first composition adjacent to the first surface, a layer of silicon oxynitride of a second composition adjacent to the second surface, wherein the second composition has more oxygen than the first composition.

3. The light absorbing element according to claim 2, wherein the phase match composite layer comprises graded composition defining the thickness of the phase match composite layer, the graded composition increasing in an amount of oxygen along a thickness direction from the first surface to the opposing second surface.

4. The light absorbing element according to claim 2, wherein the phase match composite layer comprises graded composition defining the thickness of the phase match composite layer, the graded composition decreasing in an amount of nitrogen along a thickness direction from the first surface to the opposing second surface.

5. The light absorbing element according to claim 2, wherein the phase match composite layer comprises graded composition defining the thickness of the phase match composite layer, the first surface consists essentially of silicon nitride and the second surface consists essentially of silicon oxide.

6. The light absorbing element according to claim 1, wherein the light absorbing carbon layer comprises a layer of metal and carbon of a first composition adjacent to the first surface, a layer of metal and carbon of a second composition adjacent to the second surface, wherein the second composition has more carbon than the first composition.

7. The light absorbing element according to claim 6, wherein the light absorbing carbon layer comprises a graded carbon-metal composition defining the thickness of the light absorbing carbon layer, the graded composition increasing in an amount of carbon along a thickness direction from the first surface to the opposing second surface.

8. The light absorbing element according to claim 6, wherein the light absorbing carbon layer comprises a graded carbon-metal composition defining the thickness of the light absorbing carbon layer, the graded composition decreasing in an amount of metal along a thickness direction from the first surface to the opposing second surface.

9. The light absorbing element according to claim 6, wherein the light absorbing carbon layer comprises a graded carbon-metal composition defining the thickness of the light absorbing carbon layer, the first surface consists essentially of metal, and the second surface consists essentially of carbon.

10. The light absorbing element according to claim 1, wherein the light absorbing element reflects less than 10% incident light for all wavelengths from 400 nanometers to 1200 nanometers.

11. The light absorbing element according to claim 1, wherein the phase match composite layer further comprises a layer of niobium pentoxide forming the first surface.

12. The light absorbing element according to claim 1, further comprising a layer of silicon carbide separating the light absorbing carbon layer from the phase match composite layer.

13. The light absorbing element according to claim 1, wherein the metal layer comprises a titanium tungsten alloy.

14. The light absorbing element according to claim 1, wherein the phase match composite layer has a thickness in a range from 50 to 200 nanometers, the light absorbing carbon layer has a thickness in a range from 50 to 250 nanometers, and the metal layer has a thickness in a range from 50 to 150 nanometers.

15. The light absorbing element according to claim 12, wherein the phase match composite layer has a thickness in a range from 50 to 200 nanometers, the light absorbing carbon layer has a thickness in a range from 50 to 250 nanometers, the metal layer has a thickness in a range from 50 to 150 nanometers, and the layer of silicon carbide has a thickness in a range from 10 to 20 nanometers.

16. An optical sensor article, comprising:
a silicon substrate;
a light sensor disposed in or on the silicon substrate; and
the light absorbing element according to claim 1 disposed on or in the silicon substrate and adjacent to the light sensor.

17. The optical sensor article according to claim 16, further comprising an anti-reflective layer separating the metal layer from the silicon substrate, wherein the anti-reflective layer comprises a layer of silicon oxide disposed on a layer of silicon nitride.

18. The optical sensor article according to claim 16, wherein the light absorbing element defines at least a portion of an optical cavity, the light sensor disposed in the optical cavity.

19. The optical sensor article according to claim 16, further comprising a layer of silicon carbide adhering or fixing the light absorbing carbon layer to the phase match composite layer.

20. A method of forming a light absorbing element, comprising, depositing a metal layer;
depositing a light absorbing carbon layer on the metal layer;
depositing a layer of silicon nitride onto the carbon layer;
depositing a gradient layer of silicon nitride and silicon oxide onto the layer of silicon nitride by reducing an amount of nitrogen and increasing an amount of oxygen during the depositing a gradient layer step; and
depositing a layer of silicon oxide onto the gradient layer, forming a phase match composite layer.

21. The method according to claim 20, further comprising depositing a silicon carbide layer onto the light absorbing carbon layer and then depositing a layer of silicon nitride onto the silicon carbide layer.

22. The method according to claim 20, wherein the phase match composite layer has a thickness in a range from 50 to 200 nanometers, the light absorbing carbon layer has a thickness in a range from 50 to 250 nanometers, and the metal layer has a thickness in a range from 50 to 150 nanometers.

23. The method according to claim 20, wherein the depositing a gradient layer step comprises depositing a gradient layer of silicon nitride and silicon oxide onto the layer of silicon nitride, by depositing silicon in an oxygen and nitrogen ambient and changing relative amounts of oxygen and nitrogen from a low oxygen to nitrogen ratio to a high oxygen to nitrogen ratio during the depositing a gradient layer step.

24. The method according to claim 20, wherein the depositing a light absorbing carbon layer step comprises depositing a gradient layer of metal and carbon onto the metal layer, by reducing an amount of metal and increasing an amount of carbon during the depositing a light absorbing carbon layer step.

25. The method according to claim 20, wherein the depositing a light absorbing carbon layer step comprises depositing a gradient layer of metal and carbon onto the metal layer, by co-depositing metal and carbon simultaneously and changing relative deposition rates of the metal and carbon from a low carbon to metal rate ratio to a high carbon to metal rate ratio during the depositing a light absorbing carbon layer step.
